(19) United States
(12) Patent Application Publication
(10) Pub. No.: US 2012/0093448 A1
(43) Pub. Date: Apr. 19, 2012

(54) BELLOWS BEARING, AND BEARING ASSEMBLY STRUCTURE AND MINI ROTATING DEVICE USING THE SAME

(75) Inventor: Chiang-Cheng Huang, Taipei (TW)

(73) Assignee: RISUN EXPANSE CORP., Taipei (TW)

(21) Appl. No.: 13/183,094

(22) Filed: Jul. 14, 2011

(30) Foreign Application Priority Data
Oct. 15, 2010 (TW) 099135325

(51) Int. Cl. F16C 17/12; F16C 33/74; F16C 33/10

(52) U.S. Cl. 384/130; 384/397

(57) ABSTRACT

A bellows bearing is a tube body formed by coaxially wrapping a wire. The tube body has a plurality of consecutively arranged bumps and recesses. End edges of the plurality of bumps form a contact portion, and the plurality of recesses forms an oil storage portion. Thus, when a mini rotating device using the bellows bearing rotates, a desirable lubricating, shock-resistant, and debris-removal effect can be achieved, thereby increasing the service life of the mini rotating device.

### CROSS-REFERENCE TO RELATED APPLICATIONS

This non-provisional application claims priority under 35 U.S.C. §119(a) on Patent Application No(s). 099135325 filed in Taiwan, R.O.C. on Oct. 15, 2010, the entire contents of which are hereby incorporated by reference.

### BACKGROUND

1. Field

The present invention relates to a bearing, and a bearing assembly structure and a mini rotating device using the same, and more particularly to a bellows bearing having an oil storage function, and a bearing assembly structure and a mini rotating device using the same.

2. Related Art

With the development of technologies, portable electronic products such as smart phones, satellite navigation, and personal digital assistants are currently evolving towards light, thin, short, and small structures. Due to gradual miniaturization of portable electronic products which causes that the space for heat dissipation inside the portable electronic products is rather limited, as well as high density arrangement of electronic components, a mini fan must be used to assist forced heat convection of the electronic components inside the portable electronic products, so as to accelerate the heat dissipation of the electronic components.

In the mini fan, a shaft core of a fan blade and a bearing are pivoted to each other, and the fan blade is enabled to rotate at a high rate, such that a forced air flow for heat dissipation is generated inside the portable electronic product. Therefore, smooth operation of the shaft core in the bearing must be ensured, without causing noise or friction. However, in terms of volume, the size of the current mini fan is equal to or even smaller than that of a coin worth one dollar (15×15×4 mm), and accordingly, the size of each means in the mini fan is smaller. To ensure the smooth operation of the shaft core and the bearing, oil with lubricating effect needs to be supplied between the shaft core and the bearing, so as to provide a desirable lubricating effect when the shaft core rotates.

Therefore, the design of an oil-impregnated bearing has been proposed. The oil-impregnated bearing is a structure having a plurality of hollow pores, such that the oil can respectively fill up the pores. When the shaft core rotates in the oil-impregnated bearing, the oil-impregnated bearing gradually releases the oil to gradually wet the shaft core. However, since the volume of the oil-impregnated bearing of the mini fan is too small, the amount of oil contained in the oil-impregnated bearing is rather limited. In addition, if the shaft core operates at a high rate for a long time, a high temperature will be generated between the shaft core and the oil-impregnated bearing, which easily leads to rapid volatilization of the oil of the oil-impregnated bearing, such that the oil cannot effectively enter between the shaft core and the bearing for lubrication. In the long term, it easily results in that the oil-impregnated bearing loses the effect of self-lubricating the shaft core, and if foreign matters (such as dust, impurities, or debris) enter the shaft core, it easily incurs interference between the shaft core and the oil-impregnated bearing, which further leads to abnormal sounds or unsmooth rotation, or even leads to failure of the rotation of the mini fan, thereby greatly shortening the service life of the whole mini fan. Therefore, in order to solve the problem of insufficient oil storage space for in the oil-impregnated bearing, an oil-impregnated bearing having oil storage grooves has been further developed in the prior art, that is, an oil-impregnated bearing is formed with a plurality of oil storage grooves, so as to increase the oil storage capacity of the oil-impregnated bearing. For example, Patent Publication No. M309023 discloses formation of thread grooves intersecting in opposite directions on an inner wall surface of an oil-impregnated bearing, so as to increase the oil storage capacity of the bearing. However, for oil-impregnated bearings having grooves (for example, the thread grooves intersecting in opposite directions as described above), the grooves are difficult to manufacture, and also require additional post-processing with heat treatment. Therefore, the difficulty, process time, and energy consumption for manufacturing the bearing are increased accordingly, thereby increasing the manufacturing cost of the bearing.

### SUMMARY

Accordingly, the present invention is a bellows bearing, and a bearing assembly structure and a mini rotating device using the same, so as to solve the problems in the prior art that the amount of oil contained in the bearing is insufficient, and that the bearing is difficult to manufacture.

The present invention provides a bellows bearing, being a tube body formed by coaxially wrapping a wire. The tube body has a plurality of consecutively arranged bumps and recesses formed by the wrapped wire. End edges of the plurality of bumps form a contact portion, and the plurality of recesses forms an oil storage portion.

The present invention also provides a bearing assembly structure, which comprises a sleeve and a bellows bearing. The bellows bearing is accommodated in the sleeve. The bellows bearing is a tube body formed by coaxially wrapping a wire, and the tube body has a plurality of consecutively arranged bumps and recesses formed by the wrapped wire. End edges of the plurality of bumps form a contact portion, the plurality of recesses forms an oil storage portion, and the oil storage portion is filled with a lubricating oil.

The present invention further provides mini rotating device, which comprises a bearing assembly structure and a shaft core. The bearing assembly structure comprises a sleeve and a bellows bearing. The bellows bearing is accommodated in the sleeve. The bellows bearing is a tube body formed by coaxially wrapping a wire, and the tube body has a shaft hole. The tube body has a plurality of consecutively arranged bumps and recesses formed by the wrapped wire, end edges of the plurality of bumps form a contact portion, and the plurality of recesses forms an oil storage portion. The oil storage portion is filled with a lubricating oil. The shaft core is inserted into the shaft hole of the bellows bearing, contacts with the contact portion of the bellows bearing, and rotates relative to the bellows bearing.

The bellows bearing of the present invention is formed by coaxially wrapping a wire. Therefore, the bellows bearing of the present invention has a plurality of consecutively arranged bumps and recesses, so as to respectively form a contact portion and an oil storage portion. As such, the contact area between the bellows bearing and the shaft core disposed therein can be greatly reduced, and the plurality of recesses provides a sufficient oil storage space for the bellows bearing. Thus, when the mini rotating device using the bellows bearing rotates, a desirable lubricating effect can be achieved. In addition, since the contact area between the shaft core and the bearing is reduced, the abrasion between the two is also reduced, thereby increasing the service life of the mini rotating device.

These and other aspects of the present invention will become apparent from the following description of the preferred embodiment taken in conjunction with the following drawings, although variations and modifications therein may be affected without departing from the spirit and scope of the novel concepts of the disclosure.

### BRIEF DESCRIPTION OF THE DRAWINGS

The accompanying drawings illustrate one or more embodiments of the invention and, together with the written description, serve to explain the principles of the invention. Wherever possible, the same reference numbers are used throughout the drawings to refer to the same or like elements of an embodiment, and wherein:

FIG. 1A is a schematic structural view of a bellows bearing according to an embodiment of the present invention;

FIG. 1B is a schematic sectional view of a bellows bearing according to an embodiment of the present invention;

FIG. 1C is a partially enlarged view according to FIG. 1B;

FIG. 1D is a schematic sectional view of a bellows bearing according to another embodiment of the present invention;

FIG. 1E is a partially enlarged view according to FIG. 1D;

FIG. 2A is a schematic structural view of a mini rotating device according to an embodiment of the present invention;

FIG. 2B is a schematic sectional view of a mini rotating device according to an embodiment of the present invention;

FIG. 2C is a schematic sectional view of a mini rotating device according to another embodiment of the present invention;

FIG. 3 is a schematic structural view of a mini rotating device according to another embodiment of the present invention; and

FIG. 4 is a schematic structural view of a mini rotating device according to another embodiment of the present invention.

### DETAILED DESCRIPTION

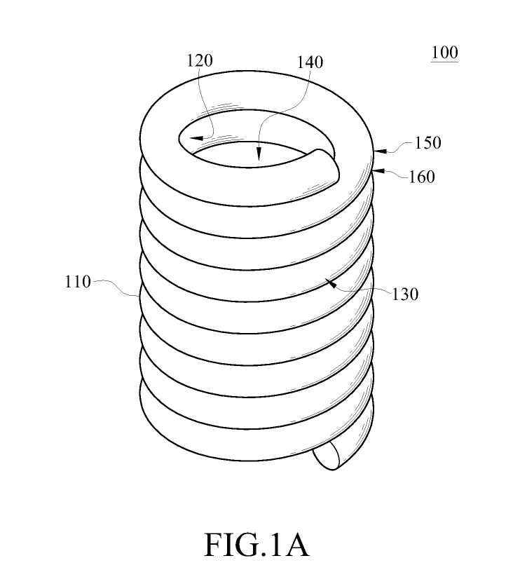

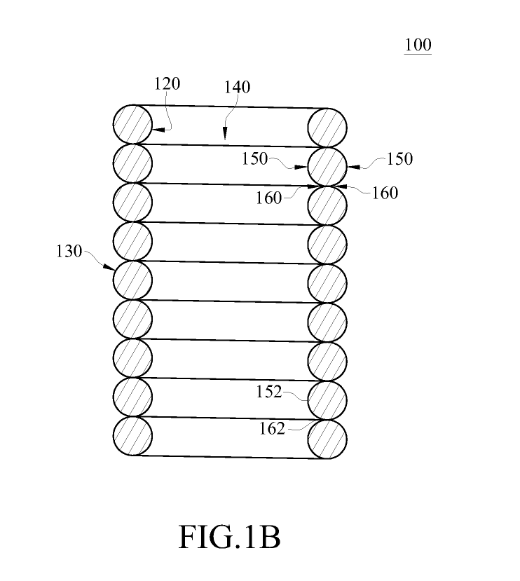

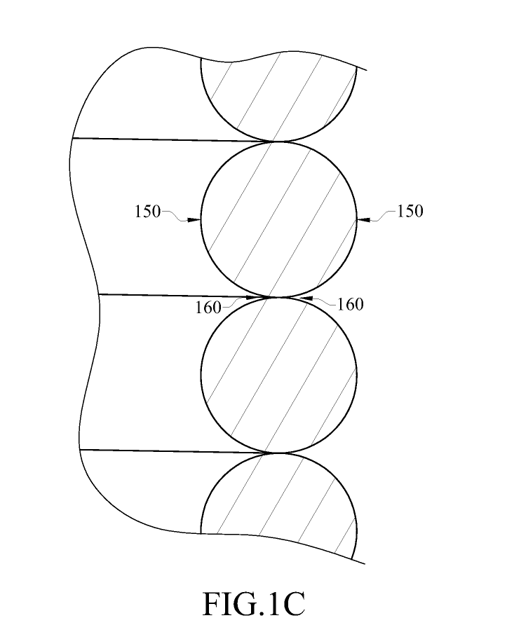

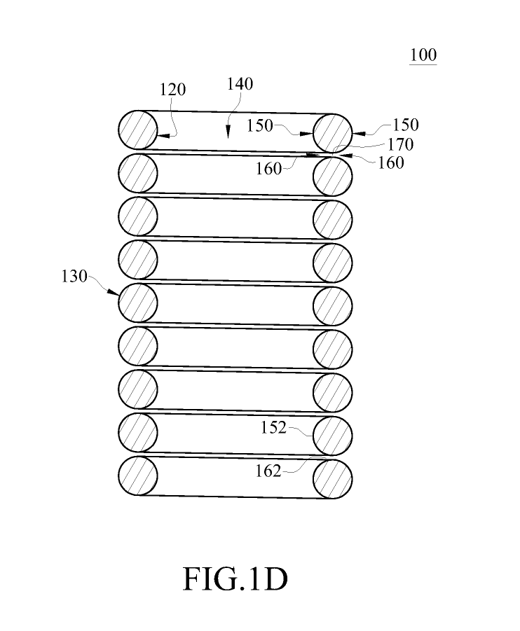

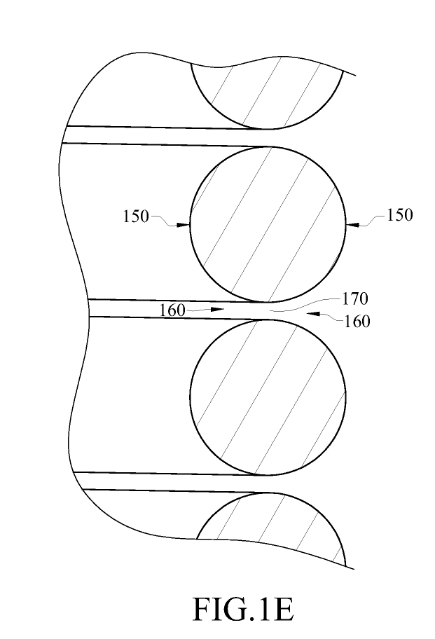

FIG. 1A is a schematic structural view of a bellows bearing according to an embodiment of the present invention; FIG. 1B is a schematic sectional view of a bellows bearing according to an embodiment of the present invention; and FIG. 1C is a partially enlarged view according to FIG. 1B.

A bellows bearing 100 of the present invention is a tube body 110 formed by coaxially wrapping a wire. The tube body 110 has a shaft hole 140 and an inner wall surface 120 and an outer wall surface 130 opposite to each other formed by the wrapped wire, and the inner wall surface 120 is a hole wall surface of the shaft hole 140. The inner wall surface 120 and the outer wall surface 130 have a plurality of consecutively arranged bumps 150 and recesses 160, end edges of the plurality of bumps 150 on the inner wall surface 120 form a contact portion 152, and the plurality of recesses 160 forms an oil storage portion 162. The shaft hole 140 is used for accommodating a shaft core, and the oil storage portion 162 is used for storing a lubricating oil. In addition, the material of the wire forming the tube body 110 may be, but is not limited to, hard bronze, soft red brass, or highly wear-resistant alloy copper.

The bellows bearing 100 of this embodiment is formed by coaxially wrapping a wire. Compared with conventional bearings made of metal particle powders through multiple manufacturing procedures such as die casting, sintering, molding, decontamination, and purging, the manufacturing process of the bellows bearing 100 of this embodiment is simple. In addition, since the bellows bearing 100 of this embodiment is manufactured by cold forging, no heat treatment is required. Compared with the manufacturing process of conventional bearings, the manufacturing process of the bellows bearing 100 of this embodiment can greatly reduce the process time and energy consumption, thereby promoting energy saving and carbon reduction.

FIG. 1D is a schematic sectional view of a bellows bearing according to another embodiment of the present invention; and FIG. 1E is a partially enlarged view according to FIG. 1D. Since the structure of this embodiment is largely identical to that of FIG. 1B, only the difference there-between is illustrated.

In the bellows bearing 100 of this embodiment, the inner wall surface 120 and the outer wall surface 130 have a plurality of consecutively arranged bumps 150 and recesses 160. End edges of the plurality of bumps 150 on the inner wall surface 120 form a contact portion 152, and the plurality of recesses 160 forms an oil storage portion 162. The wire of the bellows bearing 100 is formed with a gap 170 corresponding to the recess 160, and the gap 170 is in communication with the oil storage portion 162 on the inner wall surface 120 and the oil storage portion 162 on the outer wall surface 130. The gap 170 improves the fluidity of the lubricating oil in the oil storage portion 162, and the bellows bearing 100 forms a shock-resistant elastic body through the disposition of the gap 170.

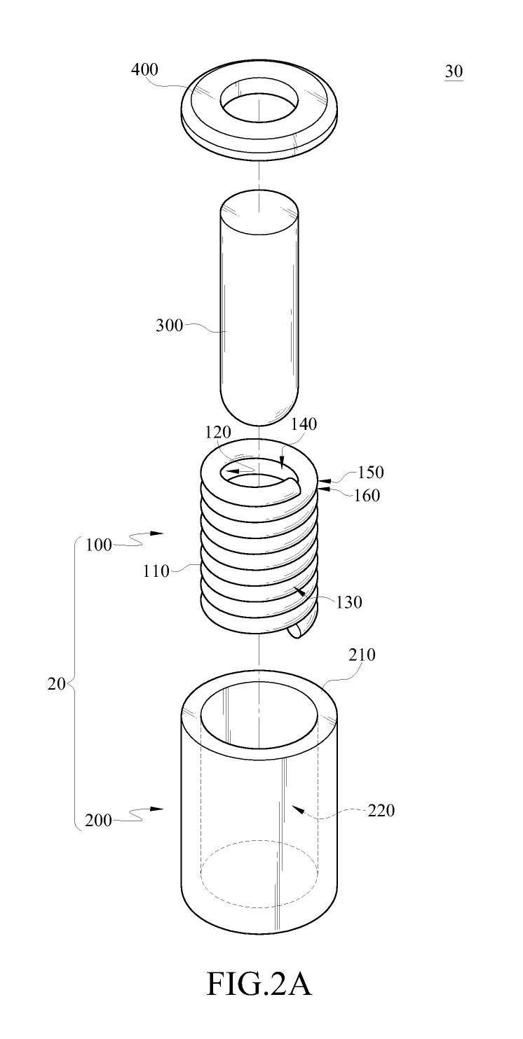

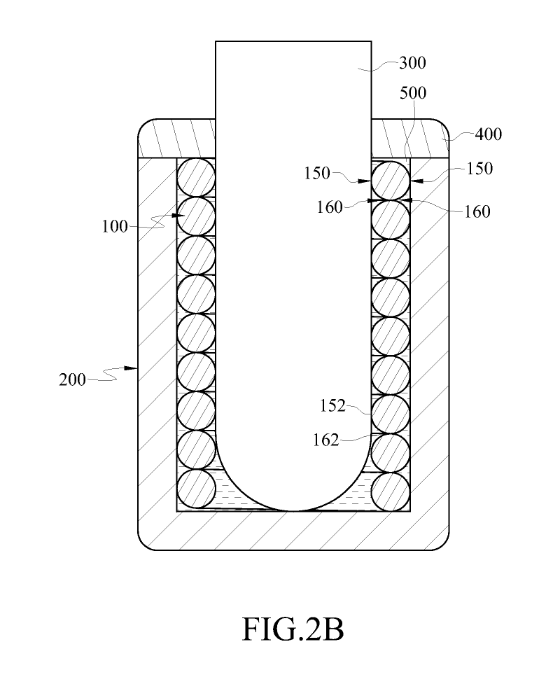

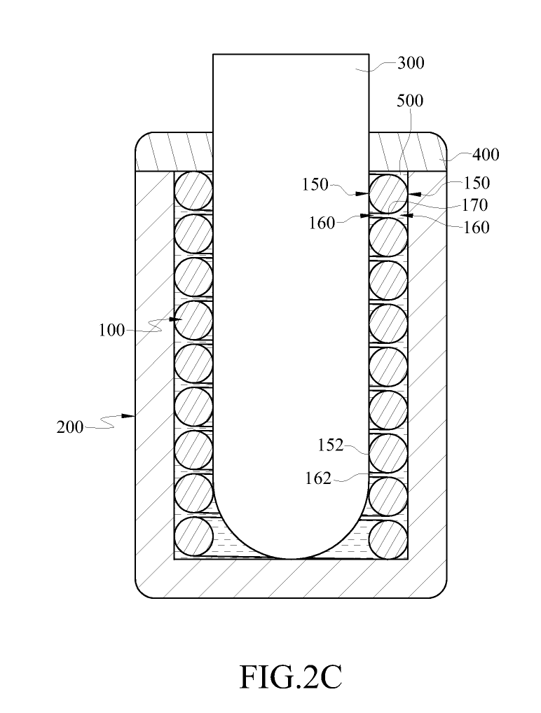

A bearing assembly structure 20 and a mini rotating device 30 using the bellows bearing 100 are illustrated below. FIG. 2A is a schematic structural view of a mini rotating device according to an embodiment of the present invention; and FIG. 2B is a schematic sectional view of a mini rotating device according to an embodiment of the present invention.

A mini rotating device 30 according to an embodiment of the present invention comprises a bearing assembly structure 20 and a shaft core 300. The bearing assembly structure 20 comprises a sleeve 200 and the bellows bearing 100. The sleeve 200 has an opened end 210, and the opened end 210 is formed with an accommodation space 220. The accommodation space 220 is used for accommodating the bellows bearing 100 and the shaft core 300. In this embodiment, the sleeve 200 has a cylindrical aspect, which, however, is not intended to limit the present invention. For example, the sleeve 200 may also have a prismatic aspect.

In addition, the bellows bearing 100 is accommodated in the accommodation space 220 inside the sleeve 200, and the bellows bearing 100 is fixed in the accommodation space 220. Since the structure of the bellows bearing 100 has been described in detail above, the details will not be described herein again. In this embodiment, the shaft core 300 is inserted into the shaft hole 140 of the bellows bearing 100, and the shaft core 300 contacts with the contact portion 152 on the inner wall surface 120 of the bellows bearing 100. The contact portion 152 fixes the shaft core 300, such that the shaft core 300 is coaxial to the shaft hole 140. The shaft core 300 can rotate relative to the bellows bearing 100.

Moreover, the mini rotating device 30 of this embodiment may further comprise an oil seal 400, and the oil seal 400 is adhered to the opened end 210 of the sleeve 200. The sleeve 200 and the oil seal 400 jointly enclose the bellows bearing 100, the shaft core 300 is disposed in the shaft hole 140 of the bellows bearing 100, and inserted to pass outside the sleeve 200 through the oil seal 400. Therefore, through the disposition of the oil seal 400, the mini rotating device 30 of this embodiment can enclose the bellows bearing 100 and the shaft core 300 into the sleeve 200, so as to prevent the bellows bearing 100 and the shaft core 300 in the accommodation space 220 from falling outside the sleeve 200.

In addition, the sleeve 200 of this embodiment may be filled with a lubricating oil 500, and the lubricating oil 500 is stored in the oil storage portion 162 of the bellows bearing 100. Another function of the oil seal 400 is to prevent the lubricating oil 500 from leaking outside the sleeve 200. Since the mini rotating device 30 of this embodiment is disposed with the bellows bearing 100, the bellows bearing 100 contacts with the shaft core 300 with the contact portion 152 in the form of line contact, so that the contact area is quite small. Therefore, when the shaft core 300 rotates relative to the bellows bearing 100, the friction between the shaft core 300 and the bellows bearing 100 is also slight, which accordingly reduces the noise generated by the shaft core 300 during rotation. In addition, since the oil storage portion 162 is just located beside the contact portion 152, the lubricating oil 500 stored in the oil storage portion 162 can continuously wet the shaft core 300, so that the abrasion between the shaft core 300 and the bellows bearing 100 can be further reduced. Moreover, the oil storage portion 162 of this embodiment may further have a debris removal function, that is, when debris is generated due to friction after long term rotation of the shaft core 300 or extraneous debris (such as dust) invades, the debris may be accumulated at the oil storage portion 162, so as to avoid interference between the shaft core 300 and the bellows bearing 100 due to the debris.

Thus, the bellows bearing 100 can ensure smooth pivoting of the shaft core 300 of the mini rotating device 30. Compared with the prior art having the problems of insufficient amount of oil contained in the bearing, excessively large friction area between the bearing and the shaft core 300, and hindering of the shaft core 300 by debris, the structure of the bellows bearing 100 of this embodiment can overcome the above problems.

FIG. 2C is a schematic sectional view of a mini rotating device according to another embodiment of the present invention. Since the structure of this embodiment is largely identical to that of FIG. 2B, only the difference there-between is illustrated.

In the mini rotating device 30 of this embodiment, the wire of the bellows bearing 100 is formed with a gap 170 corresponding to the recess 160, and the gap 170 is in communication with the oil storage portion 162 on the inner wall surface 120 and the oil storage portion 162 on the outer wall surface 130. Therefore, the gap 170 can improve the fluidity of the lubricating oil 500 in the oil storage portion 162. When the lubricating oil 500 of the oil storage portion 162 on the inner wall surface 120 is insufficient, the lubricating oil 500 of the oil storage portion 162 on the outer wall surface 130 can be supplemented immediately through the gap 170. In addition, the bellows bearing 100 forms a shock-resistant elastic body through the disposition of the gap 170. Thus, the structure of the bellows bearing 100 enables the mini rotating device 30 to be shock resistant, so that shock collision between the parts can be alleviated, thereby improving the service life of the mini rotating device 30.

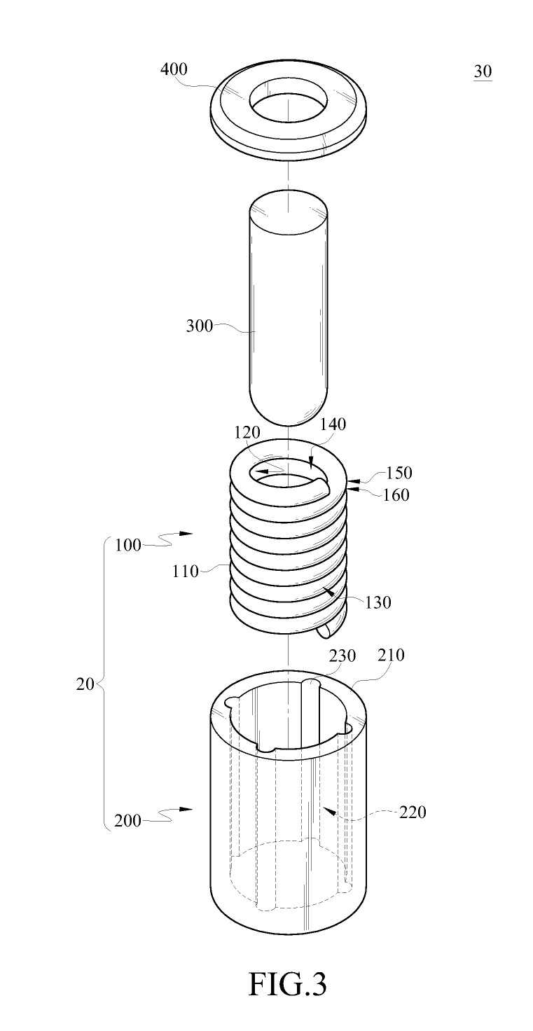

FIG. 3 is a schematic structural view of a mini rotating device according to another embodiment of the present invention. Since the structure of this embodiment is largely identical to that of FIG. 2A, only the difference there-between is illustrated.

In the mini rotating device 30 of this embodiment, a wall surface where the accommodation space 220 of the sleeve 200 of the bearing assembly structure 20 is formed may be further disposed with a plurality of grooves 230. The grooves 230 are used for storing the lubricating oil 500, such that the mini rotating device 30 can store a larger amount of the lubricating oil 500.

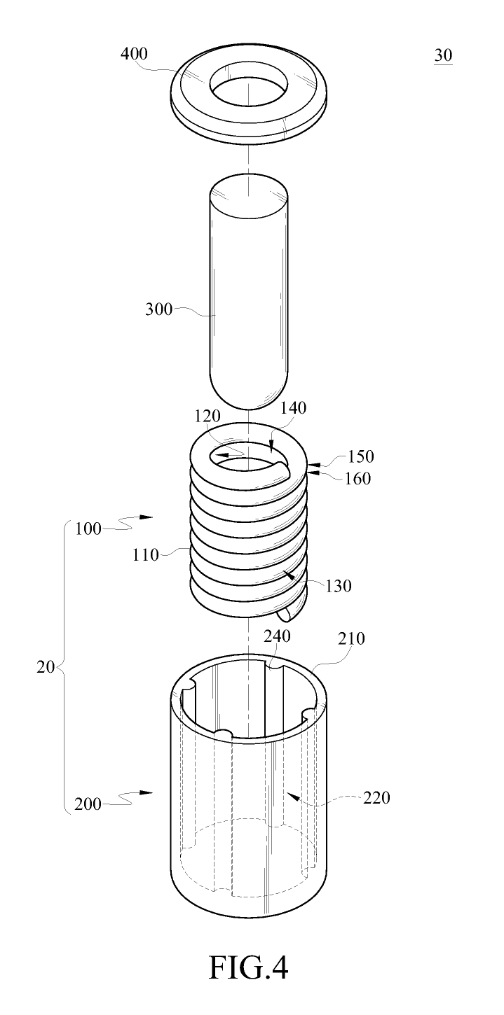

FIG. 4 is a schematic structural view of a mini rotating device according to another embodiment of the present invention. Since the structure of this embodiment is largely identical to that of FIG. 2A, only the difference there-between is illustrated.

In the mini rotating device 30 of this embodiment, a wall surface where the accommodation space 220 of the sleeve 200 of the bearing assembly structure 20 is formed may be further disposed with a plurality of ribs 240. When the bellows bearing 100 is disposed in the accommodation space 220, the ribs 240 press against the bellows bearing 100, such that the bellows bearing 100 can be stably disposed in the accommodation space 220. In addition, through the disposition of the ribs 240, the oil storage space between the bellows bearing 100 and the sleeve 200 can be increased, such that the mini rotating device 30 can store a larger amount of the lubricating oil 500.

Since the bellows bearing as disclosed above is formed by coaxially wrapping a wire, the manufacturing process thereof is simpler and more cost-effective than that of the conventional bearing. In addition, the bellows bearing of the present invention has a plurality of consecutively arranged bumps and recesses, so as to respectively form a contact portion and an oil storage portion. Furthermore, since the bellows bearing and the shaft core disposed therein are in line contact, the contact area can be greatly reduced. The plurality of recesses provides a sufficient oil storage space for the bellows bearing, and the oil storage space is used for storing the lubricating oil and providing a space for debris accumulation. Thus, when the mini rotating device using the bellows bearing rotates, a desirable lubricating, shock-resistant, and debris-removal effect can be achieved, thereby increasing the service life of the mini rotating device.

What is claimed is:

1. A bellows bearing, being a tube body formed by coaxially wrapping a wire, wherein the tube body has a plurality of consecutively arranged bumps and recesses formed by the wrapped wire, end edges of the plurality of bumps form a contact portion, and the plurality of recesses forms an oil storage portion.

2. The bellows bearing according to claim 1, wherein the wire is formed with a gap corresponding to the recess, and the gap is in communication with the oil storage portion.

3. The bellows bearing according to claim 1, wherein the tube body has a shaft hole and an outer wall surface and an inner wall surface opposite to each other, and the inner wall surface forms the shaft hole.

4. A bearing assembly structure, comprising:
a sleeve; and
a bellows bearing, accommodated in the sleeve, wherein the bellows bearing is a tube body formed by coaxially wrapping a wire, the tube body has a plurality of consecutively arranged bumps and recesses formed by the wrapped wire, end edges of the plurality of bumps form a contact portion, the plurality of recesses forms an oil storage portion, and the oil storage portion is filled with a lubricating oil.

5. The bearing assembly structure according to claim 4, wherein the wire of the bellows bearing is formed with a gap corresponding to the recess, and the gap is in communication with the oil storage portion.

6. The bearing assembly structure according to claim 4, wherein the tube body of the bellows bearing has a shaft hole and an outer wall surface and an inner wall surface opposite to each other, and the inner wall surface forms the shaft hole.

7. The bearing assembly structure according to claim 4, wherein the sleeve has an accommodation space, the accommodation space accommodates the bellows bearing, a wall surface where the accommodation space is formed is further disposed with at least one groove, and the groove is filled with the lubricating oil.

8. The bearing assembly structure according to claim 4, wherein the sleeve has an accommodation space, the accommodation space accommodates the bellows bearing, a wall surface where the accommodation space is formed is further disposed with a plurality of ribs, and the ribs press against the bellows bearing.

9. A mini rotating device, comprising:
a bearing assembly structure, comprising:
a sleeve; and
a bellows bearing, accommodated in the sleeve, wherein the bellows bearing is a tube body formed by coaxially wrapping a wire, the tube body has a shaft hole, the tube body has a plurality of consecutively arranged bumps and recesses formed by the wrapped wire, end edges of the plurality of bumps form a contact portion, the plurality of recesses forms an oil storage portion, and the oil storage portion is filled with a lubricating oil; and
a shaft core, inserted into the shaft hole of the bellows bearing, contacting with the contact portion, and rotating relative to the bellows bearing.

10. The mini rotating device according to claim 9, wherein the wire of the bellows bearing is formed with a gap corresponding to the recess, and the gap is in communication with the oil storage portion.

11. The mini rotating device according to claim 9, wherein the tube body of the bellows bearing has an outer wall surface and an inner wall surface opposite to each other, and the inner wall surface forms the shaft hole.

12. The mini rotating device according to claim 9, further comprising an oil seal, wherein the oil seal is adhered to one end of the sleeve, the sleeve and the oil seal jointly enclose the bellows bearing, and the shaft core is disposed in the shaft hole, and inserted to pass outside the sleeve through the oil seal.

13. The mini rotating device according to claim 9, wherein the sleeve has an accommodation space, the accommodation space accommodates the bellows bearing, a wall surface where the accommodation space is formed is further disposed with at least one groove, and the groove is filled with the lubricating oil.

14. The mini rotating device according to claim 9, wherein the sleeve has an accommodation space, the accommodation space accommodates the bellows bearing, a wall surface where the accommodation space is formed is further disposed with a plurality of ribs, and the ribs press against the bellows bearing.
